(19) United States
(12) Patent Application Publication
(10) Pub. No.: US 2012/0165564 A1
(43) Pub. Date: Jun. 28, 2012

(54) METHOD FOR PREPARING PURIFIED AMINOSILANE

(76) Inventors: Yoshitaka Hamada, Joetsu-shi (JP); Kazuhiro Hirahara, Joetsu-shi (JP)

(21) Appl. No.: 13/332,822

(22) Filed: Dec. 21, 2011

(30) Foreign Application Priority Data
Dec. 27, 2010 (JP) 2010-289929

(51) Int. Cl. C07F 7/10

(52) U.S. Cl. 556/410

(57) ABSTRACT

An object is to provide a highly pure aminosilane having a reduced amount of halogen impurity, which is suitable for applications of electronic materials and others. More specifically, provided is a method for preparing a purified aminosilane comprising at least the steps of treating, with an alkyl metal reagent, an aminosilane having a Si—N bond but not a Si-halogen bond and having halogen impurity content of 1 ppm (w/w) or more; and distilling the treated aminosilane.

### RELATED APPLICATION

This application claims priority from Japanese Patent Application No. 2010-289929, filed Dec. 27, 2010, the disclosure of which is incorporated by reference herein in its entirety.

### BACKGROUND OF THE INVENTION

The present invention relates to a method for preparing an aminosilane, particularly, a highly pure aminosilane which can be used as a film-forming material for electronic materials.

Aminosilanes are materials useful as a silylating agent or the like. In addition, they are attracting attention as materials for forming silicon-containing films by using chemical vapor deposition (CVD) (JP 2007-318142A) or atomic layer deposition (ALD) (JP 2003-7700A) in the manufacture of semiconductor.

According to a typical preparation of aminosilane, the aminosilane can be easily prepared by mixing a corresponding silicon halide compound and an amine under cooling and then distilling the mixture for purification. The reaction mixture obtained by the reaction between a silicon halide compound and an amine, however, contains a highly sublimable adduct derived from the amine and hydrogen halide as a by-product. When the reaction mixture is purified by distillation, the adduct is inevitably distilled together so that the aminosilane contains a high concentration of halogen impurity.

It is reported in JP 56-068686/1981 that an aminosilane containing a reduced amount of by-product can be obtained by directly reacting activated silicon with a metal amide.

### SUMMARY OF THE INVENTION

The method disclosed in JP 56-068686/1981 is useful for suppressing an amount of halogen impurity contained by an aminosilane, but it requires a special condition such as a reaction temperature of more than 200° C. On the other hand, a conventional method of reacting a silicon halide compound with an amine is excellent because it can be conducted under very simple conditions. However, a halogen impurity mixed on the order of a few ppm cannot be removed effectively even when, as a conventional method for halogen impurity reduction, the impurity is precipitated as a salt by using an excess of reactant amine or using a more basic amine as a hydrogen halide-removing reagent, or a salt formed using a high-boiling-point amine is separated by distillation.

With the foregoing in view, the present invention has been made. An object of the invention is to provide a highly pure aminosilane having a reduced amount of halogen impurity, which is suitable for applications of electronic materials and others.

The present inventors have made intensive efforts in order to achieve the object described above. As a result, it has been found that treatment of an aminosilane having an Si—N bond but having no Si-halogen bond with an alkyl metal reagent, even when this aminosilane is obtained by a reaction between a silicon halide compound and an amine, converts a hydrogen halide-amine adduct into the corresponding nonvolatile metal halide such as lithium halide and the subsequent distillation can remove a halogen impurity effectively from the aminosilane, leading to the completion of the invention.

In the invention, there is thus provided a method for preparing a purified aminosilane, comprising at least the steps of treating an aminosilane, which has a Si—N bond but no Si-halogen bond and has halogen impurity content of 1 ppm (w/w) or more, with an alkyl metal reagent; and distilling the treated aminosilane.

When the method for preparing a purified aminosilane according to the invention is used, content of halogen impurity can be reduced easily so that a high quality aminosilane can be obtained only by using simple steps. A reduction amount of halogen impurity is adjustable. For example, by using an aminosilane having the content of halogen impurity reduced to less than 1 ppm, the amount of a halogen in a film obtained using chemical vapor deposition (CVD) or the like can be reduced. Thus, an insulating film with a higher quality can be obtained.

### DETAILED DESCRIPTION OF THE PREFERRED EMBODIMENTS

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

The aminosilane to be purified is a primary amine, a secondary amine or a tertiary amine having a silicon atom, and may be a monoamine or a polyamine such as diamine. It contains 1 ppm (w/w) or more of halogen or halogens as an impurity. In the aminosilane, a silicon atom is directly bonded to the nitrogen atom of the amine. For the synthesis of such an aminosilane, it is the most common practice to use a reaction between a halosilane and an amine containing one or more hydrogen atoms bonded to the nitrogen atom. The aminosilane thus obtained contains a halogen or halogens as an impurity. The halogen impurity is present as a highly sublimable ammonium halide salt such as amine hydrochloride so that it cannot easily be removed from the aminosilane even by distillation thereof. However, according to the invention, the method of using an alkyl metal reagent can facilitate the reduction of halogen impurity.

An aminosilane to be purified may have a substituent unreactive with the alkyl metal reagent. Even if the aminosilane has a substituent reactive with the alkyl metal reagent, when the reaction rate of the alkyl metal reagent with the substituent is lower than that of the alkyl metal reagent with the ammonium halide, such an aminosilane can be also purified although the yield of the aminosilane may decrease. For example, an alkoxy group directly bonded to silicon usually reacts with the alkyl metal reagent quickly so that the alkyl metal reagent should be selected carefully for purification of such a compound. Accordingly, it is preferable to study the selectivity of the reagent between the ammonium halide and the aminosilane in advance. According to the invention, the purification method cannot be used for an aminosilane having a halogen atom boned to a silicon atom. On the other hand, the purification method is useful for an aminosilane having a hydrogen group bonded to a silicon atom because the reactivity of Si—H with the alkyl metal reagent is low.

The aminosilane to be used in the method for preparing a purified aminosilane can be easily obtained preferably by a common method, comprising a reaction between a halosilane and a secondary amine or a primary amine having a bulky substituent such as a tert-butyl group.

Any halosilane can be used insofar as it can provide an aminosilane which can be distilled for purification. The halosilane is preferably represented by the general formula:

XₙSi(R¹)₄₋ₙ

wherein X represents a halogen atom, preferably Cl, Br, or I, more preferably Cl; R¹s each independently represents a hydrogen atom, an alkyl group, or an aryl group; and n is an integer from 1 to 4.

It is preferable that R¹s each independently represents a hydrogen atom, an alkyl group having from 1 to 4 carbon atoms, or a phenyl group. R¹ preferably has at least one hydrogen atom, the reason of which will be described later.

The halosilane is preferably a chlorosilane. When the chlorosilane is used as a raw material for obtaining a carbon-free silicon-based film, examples of the chlorosilane include monochlorosilane, dichlorosilane, trichlorosilane and tetrachlorosilane. When the chlorosilane is used as a raw material for obtaining a carbon-containing silicon-based film, examples of the chlorosilane include methylchlorosilane, methyldichlorosilane, methyltrichlorosilane, dimethylchlorosilane, dimethyldichlorosilane, phenyltrichlorosilane and diphenyldichlorosilane.

Any secondary amine is fundamentally usable insofar as it can provide an aminosilane which can be distilled for purification. The secondary amine is preferably represented by the general formula:

HN(R²)₂

wherein R²s each independently represents an alkyl group.

It is preferable that R²s each independently represents an alkyl group having from 1 to 4 carbon atoms. A reaction product of the secondary amine with the halosilane is preferably represented by the general formula:

{(R²)₂N}ₙSi(R¹)₄₋ₙ

Specific examples of the secondary amine for obtaining a useful material for preparing a silicon-based film by using CVD or ALD may include dimethylamine, methylethylamine and diethylamine.

A tris(dialkylamino)silane represented by the general formula:

{(R²)₂N}₃SiR¹

and obtained by a reaction between a trihalosilane such as trichlorosilane and a secondary amine represented by the formula:

HN(R²)₂

cannot be purified easily by a conventional method because an amine salt is likely to be distilled together, making purification with rectification difficult. It is therefore particularly preferred as an aminosilane to be treated with the alkyl metal reagent according to the invention.

The primary amine having a bulky substituent is preferably an amine having a tertiary carbon atom bonded to the nitrogen atom of the amino group, more preferably represented by the general formula:

H₂NC(R³)₃

wherein R³s each represents an alkyl group.

It is preferable that R³s each independently represents an alkyl group having from 1 to 4 carbon atoms. The reaction product with the halosilane is preferably represented by the general formula:

{(R³)₃CNH}ₙSi(R¹)₄₋ₙ.

Specific examples of the primary amine having a bulky substituent include tert-butylamine and tert-amylamine.

The monoamine having one amino group in the molecule thereof has been described. The secondary amine or the primary amine having a bulky substituent includes a polyamine having two or more amino groups for each forming primary amine in the molecule thereof, a polyamine having two or more amino groups for each forming secondary amine in the molecule thereof, and a polyamine having one or more amino groups for each forming primary amine and one or more amino groups for each forming secondary amine in the molecule thereof. Such a polyamine is included because it is reacted with a halosilne to form an aminosilane whose halogen impurity may be desirably reduced.

The reaction between the halosilane and the primary or secondary amine proceeds substantially stoichiometrically in principle. However, because a hydrogen halide, which is a byproduct, forms a salt with a raw material amine, it is the common practice to design the reaction based on the calculation that two equivalents of the raw material amine is consumed. Preferably from 2.0 to 3.0 molar equivalents, more preferably from 2.2 to 2.6 molar equivalents of the amine is used per molar equivalent of halogen of the halosilane.

The above reaction is exothermic so that a solvent is usually employed and a reaction reagent is mixed under cooling. Any solvent is fundamentally usable insofar as it can be separated by distillation from the reaction product aminosilane. A solvent having a relatively low polarity is preferable in view of easy separation and removal of an amine hydrochloride salt because an additional later step of filtration of the resulting salt facilitates distillation. Specific examples of the solvent include pentane, hexane, petroleum ether, octane, isooctane, toluene and xylene. The amount of the solvent is not limited insofar as it permits efficient stirring of the reaction mixture. The solvent is used preferably in an amount of from 5 to 10 times the weight of the halosilane.

Since the above-mentioned reaction proceeds quickly, any method is usable for controlling the reaction temperature. The reaction may usually be carried out by adding the amine into a halosilane dissolved in a solvent in an atmosphere of inert gas such as nitrogen or argon. A liquid amine is added dropwise, while a gaseous amine is added directly as it is, or added dropwise as a solution of the amine in a solvent.

The reaction temperature is preferably −10° C. to 80° C. The reaction temperature may be controlled to be within the above range by using conventional cooling with cold water, ice water, ice-brine, dry ice-methanol or the like.

After the addition of the amine, the resulting mixture may be stirred at 40° C. to 80° C. for 10 minutes to 6 hours for completing the reaction.

When the boiling point of the amine is sufficiently low, the amine used in excess can be removed under reduced pressure. More preferably, the reaction mixture is filtered to remove the amine-hydrogen halide salt formed in an inert gas atmosphere to obtain a crude product solution.

The crude product solution thus obtained is subjected to primary purification by distillation. The crude product solution is subjected to distillation under normal pressure to remove the solvent used for the reaction and then distillation under reduced pressure to obtain a crude aminosilane. The aminosilane thus obtained still contains an amine-hydrogen chloride salt which has been sublimed. It usually contains a few hundred ppm of chlorine.

In the invention, the crude aminosilane containing 1 ppm (w/w) or more of halogen or halogens, which has been obtained by the above conventional method, is treated with an alkyl metal reagent to obtain an aminosilane having reduced content of halogen impurity. In this treatment, a halogen present as an ammonium halide salt (for example, amine hydrochloride salt) or the like is reacted with an alkyl metal reagent to produce a metal halide, amine and a hydrocarbon.

Any alkyl metal reagent is usable insofar as it is basic enough to easily react with the proton of the amine hydrochloride salt and allows an impurity contained by the alkyl metal reagent or a byproduct formed by a reaction between the alkyl metal reagent used in excess and the aminosilane to be separated from the aminosilane by distillation.

Examples of easily available alkyl metal reagents include an alkyl lithium reagent represented by the general formula:

R⁴Li

wherein R⁴ represents an alkyl group, and
an alkyl Grignard reagent represented by the general formula:

R⁵MgX¹

wherein R⁵ represents an alkyl group and X¹ represents a halogen atom, preferably Cl, Br or I.

In particular, the alkyl lithium reagent is effective because it has a high reactivity and produces a salt which can be easily separated from the aminosilane.

R⁴ and R⁵ each preferably represents an alkyl group having 1 to 6 carbon atoms.

When an alkyl metal reagent having 1 to 6 carbon atoms, particularly an alkyl lithium reagent having 1 to 6 carbon atoms is used, an impurity contained by the alkyl metal reagent or a byproduct formed by a reaction between the alkyl metal reagent used in excess and the aminosilane can be easily separated during distillation of the aminosilane after the treatment with the reagent. Consequently, it is a preferable reagent.

Specific examples of the alkyl lithium reagent preferably include methyl lithium, ethyl lithium, propyl lithium and butyl lithium. In particular, methyl lithium is preferable because it can be obtained easily at a low cost.

Specific examples of the alkyl Grignard reagent preferably include isopropylmagnesium chloride, sec-butylmagnesium chloride, cyclopentylmagnesium chloride, cyclohexylmagnesium chloride, isopropylmagnesium bromide, sec-butylmagnesium bromide, cyclopentylmagnesium bromide, cyclohexylmagnesium bromide, isopropylmagnesium iodide, sec-butylmagnesium iodide, cyclopentylmagnesium iodide and cyclohexylmangesium iodide.

The alkyl metal reagent is usually available as an ether-based solution whose solvent includes diethyl ether, tetrahydrofuran and methyl tert-butyl ether; or as a paraffin-based solution whose solvent includes petroleum ether and hexane. Any solution of the alkyl metal reagent can be used insofar as the solvent does not disturb the purification during distillation.

The treatment of an aminosilane with the alkyl metal reagent may be completed, for example, by adding dropwise a solution of the alkyl metal reagent in an organic solvent to the aminosilane under cooling or at room temperature and then stirring the reaction mixture. The reaction progresses sufficiently even at a low temperature so that the treatment may usually be conducted at from −10° C. to normal temperature. Since the reaction is completed quickly, the time for the treatment may be 30 minutes or so as a rough estimate.

The same treatment conditions as those typically employed for an aminosilane or an alkyl metal reagent are applicable and the treatment may be performed in a dry inert gas atmosphere.

Theoretically, one molar equivalent of the alkyl metal reagent per molar equivalent of a halogen impurity may be required. However, since the amount of the halogen impurity is trace, it is preferable to add three molar equivalents or more of the alkyl metal reagent per molar equivalent of the halogen impurity in order to increase a treatment efficiency. Addition of 10 molar equivalents or more of the alkyl metal reagent per molar equivalent of the halogen impurity does not produce a marked effect of the further excess addition. Further, addition of 0.1 molar equivalents or more of the alkyl metal reagent per molar equivalent of the aminosilane to be purified is not preferable because the aminosilane is consumed unnecessarily by the treatment.

The alkyl metal reagent is preferably used for purification of aminosilane, particularly hydroaminosilane having a Si—H bond. The Si—H bond is highly reactive with an alkali water and hydrolyzed easily so that a purification method such as water washing cannot be employed. Although the Si—H bond is reactive with an alkyl lithium reagent, a rate of reaction with the alkyl lithium reagent is markedly lower than a rate of reaction with an ammonium halide. Accordingly, a lithium halide and the corresponding amine, which are reaction products of the alkyl lithium reagent with the ammonium halide, can be provided at a high selectivity. Because the alkyl lithium reagent is used in excess, the corresponding alkylsilane, which is a reaction product with Si—H, is also produced as a matter of course. However, it can be removed by distillation when a proper alkyl group is selected. As shown in Examples, even when a methyl group is selected, sufficient separation and purification can be carried out in case of tris(dimethylamino)silane.

The aminosilane treated with the alkyl metal reagent is purified, for example, by distillation under reduced pressure again.

The treatment of the amine hydrochloride salt with the alkyl metal reagent produces a metal halide, amine and a hydrocarbon derived from the alkyl metal reagent. In this distillation step, the amine, the alkylaminosilane having a low-molecular-weight alkyl group, and the solvent contained by the alkyl metal reagent are removed easily as a fore-running, and the organic metal reagent and the metal halide remain in a residue after distillation of the aminosilane.

By using the method for preparing a purified aminosilane according to the invention, an aminosilane having halogen impurity content of preferably less than 1 ppm can be obtained.

Hereafter, specific embodiments of the present invention will be described in detail by way of examples. However, it should not be construed that the present invention is limited to those examples.

### EXAMPLES

### <Synthesis Example 1>

(synthesis of tris(dimethylamino)silane)

A 2-L flask equipped with a thermometer, a condenser capable of being cooled by dry ice/methanol, a motor stirrer and a gas inlet tube, was charged with 108 g (0.8 mol) of trichlorosilane and 1 L of hexane. After the flask was cooled to 5° C., a dimethylamine gas was introduced together with nitrogen into the flask with stirring. As soon as the introduction of dimethylamine started, white fuming and an exothermic reaction occurred simultaneously to form a white precipitate. During this time, the internal temperature increased to 60° C. After confirmation of a reflux of dimethylamine, the exothermic reaction stopped. When the internal temperature decreased to 50° C., the introduction of dimethylamine was terminated. The amount of dimethylamine introduced during that time was 260 g (5.8 mol). The dimethylamine remaining in the system was removed at 60° C. or less under reduced pressure. The residue was filtered under pressure, and hexane was removed by distillation under normal pressure. Distillation under reduced pressure provided 91 g (yield 70%) of crude tris(dimethylamino)silane. Analysis by using the titration method revealed that the resulting product contained 300 ppm of chlorine.

### <Example 1>

The 1.3 ml of a methyl lithium diethyl ether solution having a methyl lithium concentration of 1 mol/L (product of Tokyo Chemical Industry) was added to 30 g of the crude tris(dimethylamino)silane prepared in Synthesis Example 1, and the resulting mixture was stirred at room temperature for 30 minutes. Distillation under reduced pressure provided 28 g of purified product of tris(dimethylamino)silane. The purity of the purified product as measured by using gas chromatography exceeded 99.5%. The chlorine in the purified product as measured by ion chromatography was 10 ppb.

<Example 2>

In the same manner as in Example 1 except for use of 0.8 ml of an n-butyl lithium hexane solution having a methyl lithium concentration of 1.6 mol/L (product of Tokyo Chemical Industry) instead of 1.3 ml of a methyl lithium diethyl ether solution having a methyl lithium concentration of 1 mol/L, 28 g of purified product of tris(dimethylamino)silane was obtained. The purity of the purified product as measured by using gas chromatography exceeded 99.5%. The chlorine in the purified product as measured by ion chromatography was 6 ppb.

### <Example 3>

In the same manner as in Example 1 except for use of 1.3 ml of a methylmagnesium bromide THF solution having a methylmagnesium bromide concentration of 1 mol/L (product of Tokyo Chemical Industry) instead of 1.3 ml of a methyl lithium diethyl ether solution having a methyl lithium concentration of 1 mol/L, 27 g of purified tris(dimethylamino)silane was obtained. The purity of the purified product as measured by using gas chromatography exceeded 99.5%. The chlorine in the purified product as measured by ion chromatography was 12 ppb.

### <Comparative Example 1>

After 30 g of the crude tris(dimethylamino)silane prepared in Synthesis Example 1 was diluted with 100 ml of n-hexane, the resulting mixture was washed with an aqueous 20% by weight NaOH solution. However, a large quantity of gas was released with simultaneous white precipitation, failing to obtain an intended product.

### <Comparative Example 2>

After 30 g of the crude tris(dimethylamino)silane prepared in Synthesis Example 1 was diluted with 100 ml of n-hexane, the resulting mixture was subjected to introduction of a dimethylamine gas together with nitrogen from the gas inlet tube while stirring. Then white fuming occurred and slight clouding was observed. The dimethylamine remaining in the system was removed at 60° C. or less under reduced pressure. The residue was filtered, and hexane was removed by distillation under normal pressure. Distillation under reduced pressure provided 26 g of purified product. The purity of the purified product as measured by gas chromatography exceeded 99.5%. However, the chlorine content analyzed using ion chromatography was 6 ppm.

### <Comparative Example 3>

After 30 g of the crude tris(dimethylamino)silane prepared in Synthesis Example 1 was diluted with 100 ml of n-hexane, the resulting mixture was subjected to introduction of a dimethylamine gas together with nitrogen from the gas inlet tube while stirring. Then white fuming occurred and slight clouding was observed. After it was confirmed that no clouding occurred further, the introduction was continued for further five minutes. The dimethylamine remaining in the system was removed at 60° C. or less under reduced pressure. The residue was filtered, and hexane was removed by distillation under normal pressure. Distillation under reduced pressure provided 26 g of purified product. The purity of the purified product as measured by gas chromatography exceeded 99.5%. However, the chlorine content analyzed using ion chromatography was 6 ppm.

<Comparative Example 4>

After 30 g of the crude tris(dimethylamino)silane prepared in Synthesis Example 1 was diluted with 100 ml of n-hexane, the resulting mixture was subjected to dropwise addition of 1.3 g of triethylamine while stirring. The stirring was continued for 6 hours at room temperature. Then the reaction mixture was filtered, and hexane and excess triethylamine were removed by distillation under normal pressure. Distillation under reduced pressure provided 25 g of purified product. The purity of the purified product as measured by gas chromatography exceeded 99.5%. However, the chlorine content analyzed using ion chromatography was 3 ppm.

### <Comparative Example 5>

After 30 g of the crude tris(dimethylamino)silane prepared in Synthesis Example 1 was diluted with 100 ml of n-hexane, the resulting mixture was subjected to dropwise addition of 3.4 g of trihexylamine while stirring. The stirring was continued for 6 hours at room temperature. Then the reaction mixture was filtered and hexane was removed by distillation under normal pressure. Distillation under reduced pressure provided 24 g of purified product. The purity of the purified product as measured by gas chromatography exceeded 99.5%. However, the chlorine content analyzed using ion chromatography was 4 ppm.

When methyl lithium (Example 1), n-butyl lithium (Example 2), and methylmagnesium bromide (Example 3) were used for purification of crude tris(dimethylamino)silane, chlorine contents were reduced to 10 ppm, 6 ppb and 12 ppb, respectively. On the other hand, an aqueous solution of NaOH for purification of the crude tris(dimethylamino)silane could not provide an intended product (Comparative Example 1). Even when dimethylamine (Comparative Example 2 and Comparative Example 3), triethylamine (Comparative Example 4), and trihexylamine (Comparative Example 5) were used, chlorine contents were 6 ppm, 3 ppm and 4 ppm, respectively. Thus, the chlorine content could not be reduced to less than 1 ppm.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

1. A method for preparing a purified aminosilane, comprising at least the steps of:
treating, with an alkyl metal reagent, an aminosilane having an Si—N bond but not having an Si-halogen bond and having halogen impurity content of 1 ppm (w/w) or more; and
distilling the treated aminosilane.

2. The method for preparing a purified aminosilane according to claim 1, wherein said alkyl metal reagent is an alkyl lithium reagent.

3. The method for preparing a purified aminosilane according to claim 1, wherein said alkyl metal reagent has an alkyl group having from 1 to 6 carbon atoms.

4. The method for preparing a purified aminosilane according to claim 1, wherein three molar equivalents or more of said alkyl metal reagent per molar equivalent of halogen in a halogen impurity are used.

5. The method for preparing a purified aminosilane according to claim 1, wherein said aminosilane is a tris(dialkylamino)silane in which the dialkylamino represents an amino group having two C₁₋₄ alkyl groups which may be same or different.
